(19) United States
(12) Patent Application Publication
(10) Pub. No.: US 2008/0225554 A1
(43) Pub. Date: Sep. 18, 2008

(54) BACK LIGHT MODULE

(75) Inventors: Yu-Chen Ting, Changhua County (TW); Kuo-Jui Huang, Taichung County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: WINTEK CORPORATION, Taichung (TW)

(21) Appl. No.: 12/046,440

(22) Filed: Mar. 11, 2008

(30) Foreign Application Priority Data
Mar. 12, 2007 (TW) 96108407

(51) Int. Cl. F21V 8/00

(52) U.S. Cl. 362/620

(57) ABSTRACT

A back light module includes a light guide plate, a light emitting unit, and a prism sheet. The light guide plate has a bottom surface, a light output surface opposite to the bottom surface, a light incident surface connected to the bottom surface and the light output surface, and multiple cambered diffusion portions on the light output surface. The cambered diffusion portions are paralleled to one another. Each cambered diffusion portion has a cambered surface. The light emitting unit is disposed near the light incident surface. The prism sheet is disposed over the cambered diffusion portions and has multiple linear prisms protruding toward the light guide plate. The linear prisms are paralleled to one another. The stretching direction of the linear prisms is substantially perpendicular to that of the cambered diffusion portions. Backlight uniformity can be improved and the viewing angle of the backlight system also increases in specific direction.

### CROSS-REFERENCE TO RELATED APPLICATION

This application claims the priority benefit of Taiwan application serial no. 96108407, filed on Mar. 12, 2007. The entirety of the above-mentioned patent application is hereby incorporated by reference herein and made a part of this specification.

### BACKGROUND OF THE INVENTION

1. Field of the Invention

The present invention relates to a back light module, and more particularly, to a back light module having a light guide plate.

2. Description of Related Art

As the opto-electric industry advances, liquid crystal displays are being used extensively in all kinds of electronic products. The images of liquid crystal displays are displayed through the planar light source provided by the back light module inside the liquid crystal displays. Therefore, the back light module is considered as an important device in a liquid crystal display.

FIG. 1 is a schematic cross-sectional view illustrating a conventional back light module. Please refer to FIG. 1. A conventional back light module 100 includes a light source 110, a light guide plate 120 and a prism sheet 130 disposed over the light guide plate 120. The light guide plate 120 includes a light incident surface 120a, a light output surface 120b, a bottom surface 120c and a plurality of dots 122 on the bottom surface 120c. Herein, the light source 110 is usually a cold cathode fluorescence lamp (CCFL). Further, the light source 110 is disposed adjacent to the light incident surface 120a for emitting light to the light incident surface 120a and facilitating light to enter the light guide plate 120. Light is transmitted within the light guide plate 120 through the dots 122. When the angle formed by the normal line N of the light output surface 120b and the light is smaller than the total reflection angle, light leaves the light guide plate 120 from the light output surface 120b.

According to Snell's law, when light leaves the light guide plate 120, the direction that the light travels deviates from the normal line N of the light output surface 120b. Nonetheless, as shown in FIG. 1, the prism sheet 130 disposed on the light guide plate 120 can refract and reflect light to change the direction that light travels after the light penetrates through the prism 130 to towards the normal line N. When the back light module 100 is used in a liquid crystal display, the brightness of the liquid crystal display is decreased as the viewing angle increases. Therefore, the viewing angle of conventional liquid crystal display is small.

### SUMMARY OF THE INVENTION

The present invention is directed to a back light module that is suitable for use in liquid crystal displays and adapted to resolve the problem of uneven distribution of light near the light incident surface by uniformly diffusing light to a specific direction and increasing the viewing angle.

The present invention is directed to a back light module that includes a light guide plate, a light emitting unit and a prism sheet. The light guide plate includes a bottom surface, a light output surface opposite to the bottom surface, and a light incident surface connected to the light output surface and the bottom surface. Herein, the light guide plate includes a plurality of cambered diffusion portions on the light output surface. The cambered diffusion portions are paralleled to one another. Each cambered diffusion portion has a cambered surface. The light emitting unit is disposed near the light incident surface. Further, the prism sheet is disposed over the cambered diffusion portions. The prism sheet includes a plurality of linear prisms protruding toward the light guide plate. Herein, the linear prisms are paralleled to one another. Further, the stretching direction of the linear prisms is substantially perpendicular to that of the cambered diffusion portions.

In one embodiment of the present invention, the cambered surface of each cambered diffusion portion corresponds to a first arc angle that is between 39° and 140°.

In one embodiment of the present invention, the width of each cambered diffusion portion is between 0.01 mm and 0.2 mm.

In one embodiment of the present invention, the width of each cambered diffusion portion is W, the height of each cambered diffusion portion is H, and the value of W/H is between 2.8 and 11.7. In one embodiment of the present invention, the stretching direction of the light incident surface is substantially perpendicular to that of the cambered diffusion portions.

In one embodiment of the present invention, the light incident surface includes a plurality of curved surfaces.

In one embodiment of the present invention, an end of the cambered diffusion portions is connected to the curved surfaces.

In one embodiment of the present invention, each said curved surface is a concave surface or a convex surface.

In one embodiment of the present invention, each said concave surface or concave surface corresponds to a second arc angle that is between 62° and 164°.

In one embodiment of the present invention, the light emitting unit includes a plurality of light emitting diodes.

In one embodiment of the present invention, the light emitting diodes are evenly spaced by a distance D1. Further, the light emitted by the light emitting diodes generates an effective region on the light output surface of the light guide plate. The distance between the periphery of the effective region and the light incident surface is D2. Additionally, D1 and D2 satisfy the following mathematical formula: D2≧P*D1. Herein, P is a coefficient that decreases as the second arc angle increases.

In one embodiment of the present invention, when the second arc angle is 62°, the mathematical formula D2≧0.59D1 is satisfied. When the second arc angle is 164°, the mathematical formula D2≧0.3D1 is satisfied.

In one embodiment of the present invention, the bottom surface includes a plurality of light guide elements. These light guide elements are paralleled to one another. Further, the stretching direction of the light guide elements is substantially perpendicular to that of the cambered diffusion portions. In one embodiment of the present invention, each said light guide element is a groove in the concave light guide plate, preferably a v-groove. Each groove includes a light guiding surface. Further, the angle formed by the light guiding surface and a reference plane extended from the bottom surface is between 1° and 7°.

In one embodiment of the present invention, each light guide element is a bottom prism unit protruding from the light guide plate. Further, each bottom prism unit has a light guiding surface. The angle formed by the light guiding surface and a reference plane extended from the bottom surface is between 1° and 7°.

In one embodiment of the present invention, the back light module further includes a diffuser. Herein, the diffuser is disposed on the prism sheet.

The embodiment of the present invention employs a light guide plate having a plurality of cambered diffusion portions and a prism sheet having a plurality of linear prisms protruding toward the light guide plate. Herein, the stretching direction of the linear prisms is substantially perpendicular to that of the cambered diffusion portions. Hence, when light emitted by the light emitting units is sequentially passing through the cambered diffusion portions and the linear prisms, light is uniformly dispersed toward a specific direction. In contrast to the conventional art, the brightness generated by the back light module of the present invention is not easily decayed as the viewing angle increases, resolving the issue of small viewing angle encountered by the conventional liquid crystal display.

In order to the make the aforementioned and other objects, features and advantages of the present invention more comprehensible, preferred embodiments accompanied with figures are described in detail below.

### BRIEF DESCRIPTION OF THE DRAWINGS

FIG. 1 is a schematic cross-sectional view illustrating a conventional back light module.

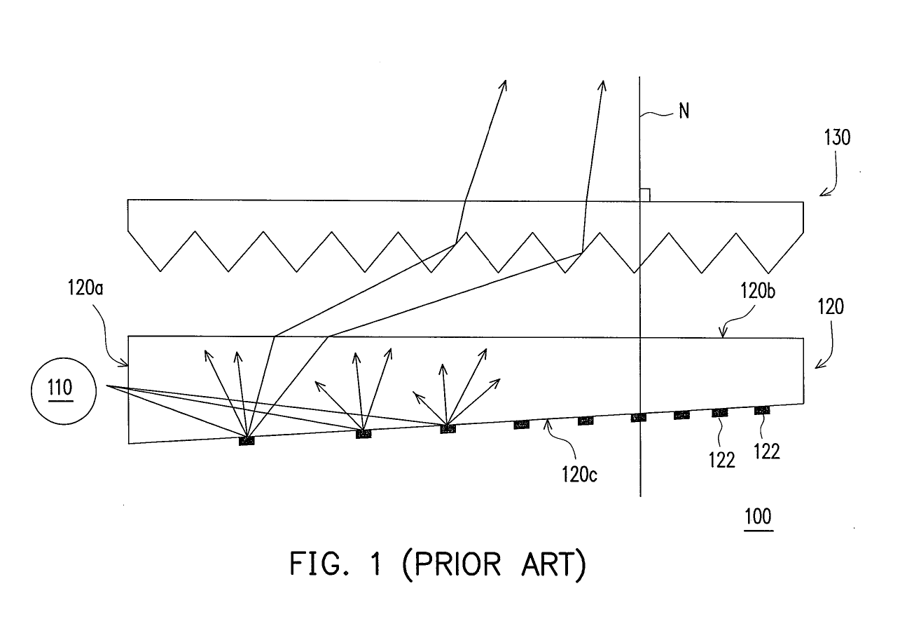

FIG. 2A is a schematic three-dimensional view illustrating a back light module according to the first embodiment of the present invention.

FIG. 2B is a schematic cross-sectional view illustrating the back light module of FIG. 2A along line I-I.

FIG. 2C is a schematic cross-sectional view illustrating the back light module of FIG. 2A along line J-J.

FIG. 2D is a schematic top view illustrating the back light module of FIG. 2A without showing the prism sheet and the light emitting unit emitting light.

FIG. 2E is another schematic top view illustrating the back light module according to the first embodiment of the present invention without showing the prism sheet and the light emitting unit emitting light.

FIG. 3 is a schematic three-dimensional view illustrating a back light module according to the second embodiment of the present invention.

FIG. 4A is a schematic three-dimensional view illustrating a back light module according to the third embodiment of the present invention.

FIG. 4B is a schematic cross-sectional view illustrating the back light module of FIG. 4A along line K-K.

### DESCRIPTION OF EMBODIMENTS

### The First Embodiment

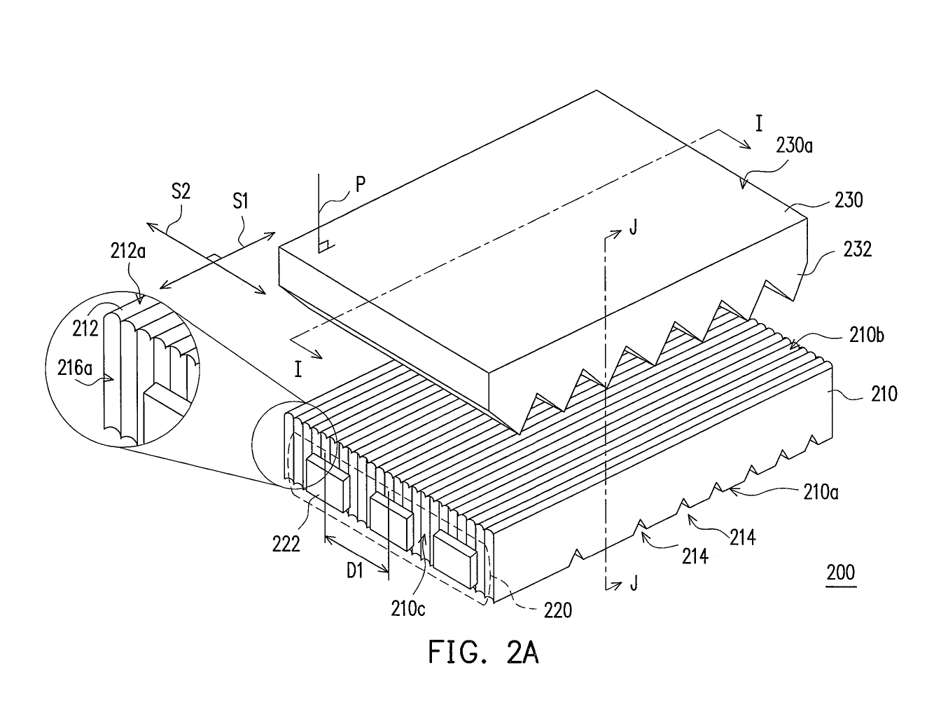

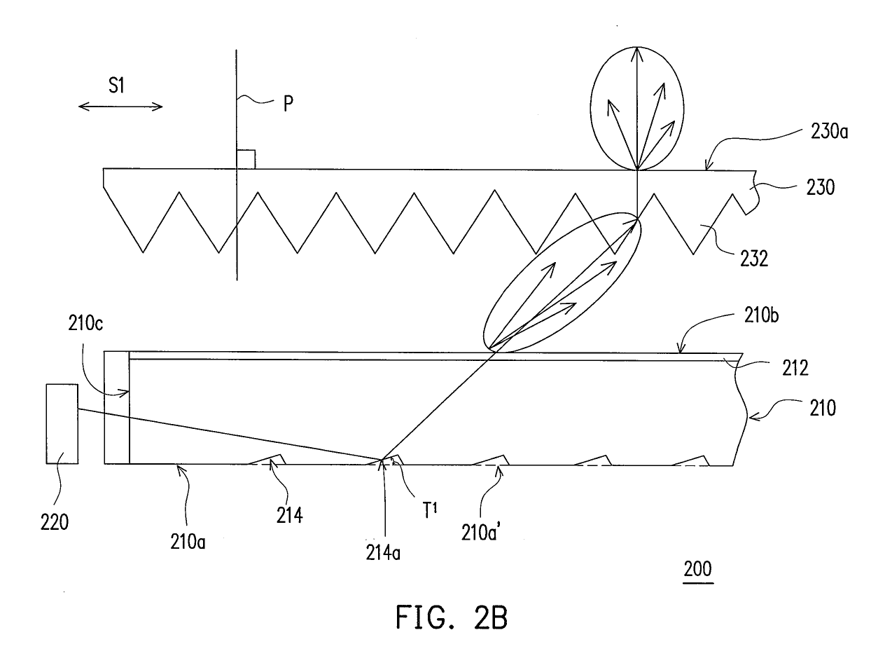

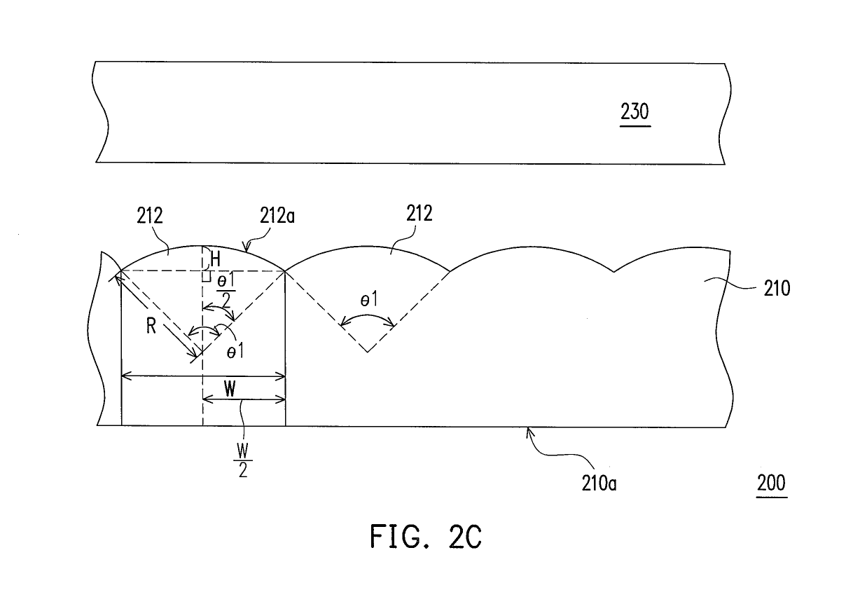

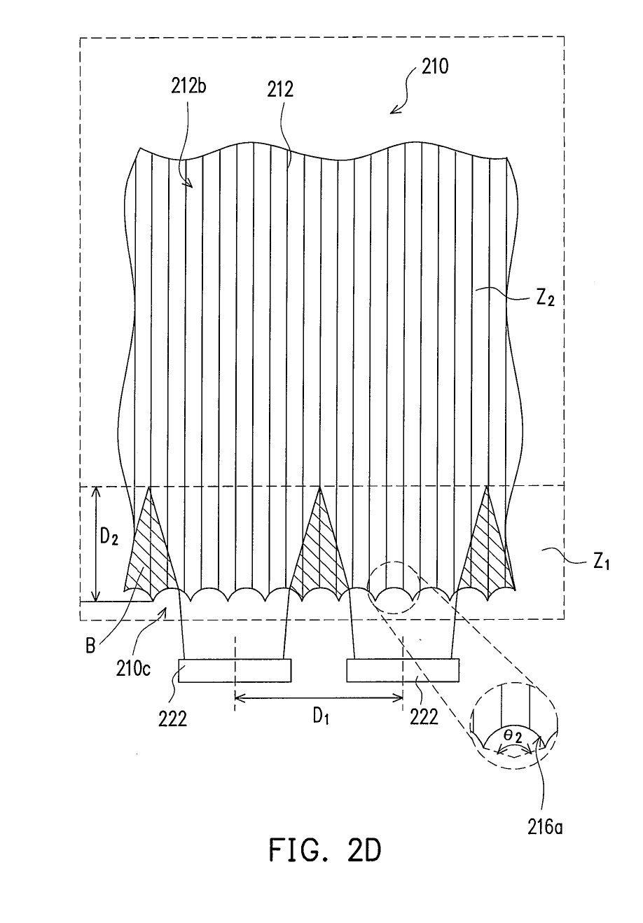

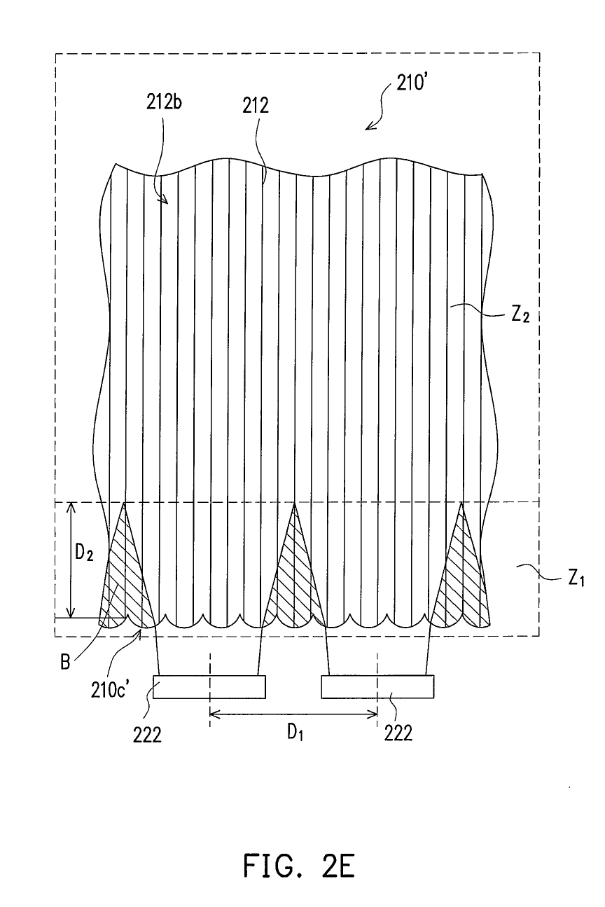

FIG. 2A is a schematic three-dimensional view illustrating a back light module according to the first embodiment of the present invention. Please refer to FIG. 2A. A back light module 200 includes a light guide plate 210, a light emitting unit 220, and a prism sheet 230. Herein, the light guide plate 210 include a bottom surface 210a, a light output surface 210b opposite to the bottom surface 210a, a light incident surface 210c connected to the light output surface 210b and the bottom surface 210a, and a plurality of cambered diffusion portions 212 on the light output surface 210b. The cambered diffusion portions 212 are paralleled to one another. Each cambered diffusion portion 212 has a cambered surface 212a.

The light emitting unit 220 is disposed near the light incident surface 210c through coupling, tight contact or adjoining, and the light emitting unit 220 emits light to the light incident surface 210c. The prism sheet 230 is disposed over the cambered diffusion portions 212. Further, the prism sheet 230 includes a plurality of linear prisms 232 protruding toward the light guide plate 210. The linear prisms 232 are paralleled to one another. Further, the stretching direction S2 of the linear prisms 232 is substantially perpendicular to the stretching direction S1 of the cambered diffusion portions 212.

It should be noted that the stretching direction S2 of the linear prisms 232 is substantially perpendicular to the stretching direction S1 of the cambered diffusion portions 212. Under unintended circumstances, the stretching direction S2 of the linear prisms 232 is not perpendicular to the stretching direction S1 of the cambered diffusion portions 212. For example, errors generated during the fabrication of the back light module 200 can cause a slight shift in the perpendicularity of the stretching direction of the linear prisms 232 to that of the cambered diffusion portions 212. Nevertheless, it should be noted that this kind of fabrication error does not affect the overall function of the back light module 200. Therefore, when the slight shift in the perpendicularity caused by said fabrication error occurs, the stretching direction of the linear prisms 232 and that of the cambered diffusion portions 212 are considered to be substantially perpendicular.

FIG. 2B is a schematic cross-sectional view illustrating the back light module of FIG. 2A along line I-I. Please refer to FIG. 2A and FIG. 2B. In the present embodiment, the light guide plate 210 includes a plurality of light guide elements such as grooves 214 (as shown in FIGS. 2A and 2B) formed in the bottom surface 210a. These grooves 214 can be V-grooves and can be paralleled to one another. Further, the stretching direction of the grooves 214 is substantially perpendicular to the stretching direction S1 of the cambered diffusion portions 212. In other words, the stretching direction of the grooves 214 is paralleled to the stretching direction S2 of the linear prisms 232 and each groove 214 has a light guiding surface 214a. As shown in FIG. 2B. in the present embodiment, the space between grooves 214 is decreased as the distance between the grooves 214 and the light incident surface 210c increases.

Please refer to FIG. 2B, when the light emitting unit 220 emits light to the light incident surface 210c, light passes through the light incident surface and evenly diffuses in the light guide plate 210. Next, the light is reflected or dispersed by the light guiding surface 214a of the grooves 214 in the bottom surface 210a, and then leave the light guide plate 210 through the cambered diffusion portions 212.

In the present embodiment, an angle T1 is formed by the light guiding surface 214a and a reference plane 210a′ extended from the bottom surface 210a and the angle T1 is between 1° and 7°, for example.

In addition, the cambered surfaces 212a (as shown in FIG. 2A) of the cambered diffusion portions 212 on the light guide plate 210 directs the dispersion of light leaving from the light guide plate 210 to towards the direction S2 to uniformly distribute the light.

After the light leaves the light guide plate 210, the light penetrates through the linear prisms 232 and is then emitted from the light output surface 230a of the prism sheet 230. When the light enters the prism sheet 230, the linear prisms 232 alter the direction of the light traveling along the direction S1 to towards the normal line P of the light output surface 230a. In other words, the linear prisms 232 converge the light dispersing along the direction S1 to increase the brightness of the light output surface 230a along the direction of the normal line P.

Since the stretching direction S2 of the linear prisms 232 is substantially perpendicular to the stretching direction S1 of the cambered diffusion portions 212, the light dispersing along the direction S2 is slightly affected by the prism sheet 230. In other words, the light leaving from the light output surface 230a of the prism sheet 230 still disperses along the direction S2. Hence, utilizing the feature of the light dispersing along the direction S2 ensures that the brightness of the liquid crystal display is not easily reduced as the viewing angle increases, overcoming the issue of the small viewing angle encountered by the conventional art.

FIG. 2C is a schematic cross-sectional view illustrating the back light module of FIG. 2A along line J-J. Please refer to FIG. 2C. In the present embodiment, the cambered surface 212a of each cambered diffusion portion 212 corresponds to a first arc angle θ1. Specifically, according to FIG. 2C, each cambered surface 212a appears as an arc and this arc (i.e. the cambered surface 212a) corresponds to the first arc angle Further, each cambered surface 212a corresponds to a radius R. The angle of the first arc angle θ1 is bigger than 0° and is smaller than or equal to 180°. Additionally, each cambered diffusion portion has a width W. The first arc angle θ1 and the width W can determine the shape of the cambered diffusion portion 212. In an alternative embodiment, the first arc angle θ1 of the cambered surface 212a is between 39° and 140°, and the width W is between 0.01 mm and 0.2 mm.

Also, the shape of the cambered diffusion portion 212 can be determined by the height H and the width W of the cambered diffusion portion 212. As shown in FIG. 2C, in one cambered diffusion portion 212, the height H, the width W, the radius R and the first arc angle θ1 satisfy the following mathematical formulae:

$$\begin{matrix}cos \frac{θ 1}{2} = \frac{R - H}{R} & ( 1 ) \\ sin \frac{θ 1}{2} = \frac{W}{2 R} & ( 2 )\end{matrix}$$

Herein, formula (2) can be re-written as formula (3) as shown below:

$$\frac{1}{R} = \frac{2 sin \frac{θ 1}{2}}{W} \qquad ( 3 )$$

Substitute formula (3) into formula (1) to obtain formula (4) as shown below:

$$\frac{W}{H} = \frac{2 sin \frac{θ 1}{2}}{1 - cos \frac{θ 1}{2}} \qquad ( 4 )$$

Respectively multiply the numerator and the denominator in formula (4) by

$$( 1 + cos \frac{θ 1}{2} )$$

to obtain formula (5). Formula (5) and the calculation thereof are shown below:

$$\begin{matrix}\frac{W}{H} = \frac{2 sin \frac{θ 1}{2} ( 1 + cos \frac{θ 1}{2} )}{( 1 - cos \frac{θ 1}{2} ) ( 1 + \frac{θ 1}{2} )} \\ = \frac{2 sin \frac{θ 1}{2} ( 1 + cos \frac{θ 1}{2} )}{1 - {cos}^{2} \frac{θ 1}{2}} \\ = \frac{2 sin \frac{θ 1}{2} ( 1 + cos \frac{θ 1}{2} )}{{sin}^{2} \frac{θ 1}{2}} \\ = \frac{2 ( 1 + cos \frac{θ 1}{2} )}{sin \frac{θ 1}{2}}\end{matrix} \qquad ( 5 )$$

According to formula (5), the first arc angle θ1 is bigger than 0° and is smaller than or equal to 180°. Therefore, as the first arc angle θ1 increases, the denominator,

$$( sin \frac{θ 1}{2} ) ,$$

in the formula increases as well. However, the numerator

$$2 ( 1 + cos \frac{θ 1}{2} )$$

in the formula decreases.

Hence, the ratio of the width W to the height H (i.e. W/H) decreases as the first arc angle θ1 increases. In an alternative embodiment, the first arc angle θ1 is between 39° and 140°. When θ1 is 39°, the value of W/H is approximately 11.7. On the other hand, when θ1 is 140°, the value of W/H is approximately 2.8. Accordingly, in the alternative embodiment, the value of W/H is between 2.8 and 11.7.

Please refer to FIG. 2A. In the present embodiment, the light emitting unit 220 can be a cathode fluorescence lamp (CCFL) or can include a plurality of light emitting diodes 222 (as shown in FIG. 2A). According to the embodiment shown in FIG. 2A, the light emitting diodes 222 can be evenly spaced by a distance D1. Herein, the preferred value for the distance D1 is between 2 mm and 15 mm, for example. Further, the light incident surface 210c is substantially perpendicular to the stretching direction S1 of the cambered diffusion portions 212, and the light incident surface 210c includes a plurality of curved surfaces. An end of the cambered diffusion portion 212 is connected to the curved surfaces of the light incident surface 210c. Additionally, each curved surface is a concave surface 216a (as shown in FIG. 2A).

FIG. 2D is a schematic top view illustrating the back light module of FIG. 2A without showing the prism sheet and the light emitting unit emitting light. The structure of the light incident surface 210c is further illustrated based on FIG. 2D. Please refer to FIG. 2D. Each concave surface 216a corresponds to a second arc angle θ2. Specifically, according to FIG. 2D, each concave surface 216a appears as an arc and this arc corresponds to the second arc angle θ2. In an alternative embodiment, the second arc angle θ2 is between 62° and 164°.

When each light emitting diode 222 emits light to the light guide plate 210, the light leaves the light guide plate 210 from the light output surface 210b. In the mean time, a plurality of dark lines B are generated on a portion of the region on the light output surface 210b of the light guide plate 210 to form a dark line zone Z1. On the other hand, an effective zone Z2 is formed on another portion of the region on the light output surface 210b due to uniform brightness. In a liquid crystal display (LCD), this effective zone Z2 corresponds to the active area of the LCD panel, ensuring uniform brightness for the images of the LCD.

The distance between the periphery of the effective zone Z2 and the light incident surface 210c is D2. As the distance D2 decreases, the area of the effective zone Z2 increases and the area of the dark line zone Z1 decreases. In other words, when the distance D2 is decreased, the area of the effective zone Z2 can be increased. Herein, the parameters affecting the distance D2 include the distance D1 between the light emitting diodes 222 and the second arc angle θ2.

When the light emitted by the light emitting unit 220 enters the light guide plate 210, the concave surfaces 216a increase the angle of dispersion to reduce the distance D2. In an alternative embodiment, the second arc angle θ2 is between 62° and 164°, and D1 and D2 satisfy the following mathematical formula: D2≧P*D1. Herein, P is a coefficient. When the second arc angle θ2 increases, the coefficient P decreases. When the second arc angle θ2 is 62°, the mathematical formula D2≧=0.59D1 is satisfied. On the other hand, when the second arc angle θ2 is 164°, the mathematical formula D2≧0.3D1 is satisfied.

According to the formula, when the distance D1 between the light emitting diodes 222 is 5 mm and the second arc angle θ2 of each concave surface 216a is 62°, the distance D2 between the periphery of the effective zone Z2 and the light incident surface 210c is approximately 2.95 mm. As a result, controlling the distance D1 and the second arc angle θ2 can effectively reduce the distance D2 between the periphery of the effective zone Z2 and the light incident surface 210c, which consequently reduces the area of the dark line zone Z1.

FIG. 2E is another schematic top view illustrating the back light module according to the first embodiment of the present invention without showing the prism sheet and the light emitting unit emitting light. Please refer to FIG. 2E. A light guide plate 210′ is shown in FIG. 2E. Herein, a light incident surface 210c′ of the light guide plate 210′ includes a plurality of convex surfaces 216b. The convex surfaces 216b also increase the angle of dispersion after the light enters the light guide plate 210′ to reduce the distance D2. Therefore, the light incident surface of the light guide plate according to the present invention can include a plurality of concave surfaces (as shown in FIG. 2D) or a plurality of convex surfaces (as shown in FIG. 2E).

### The Second Embodiment

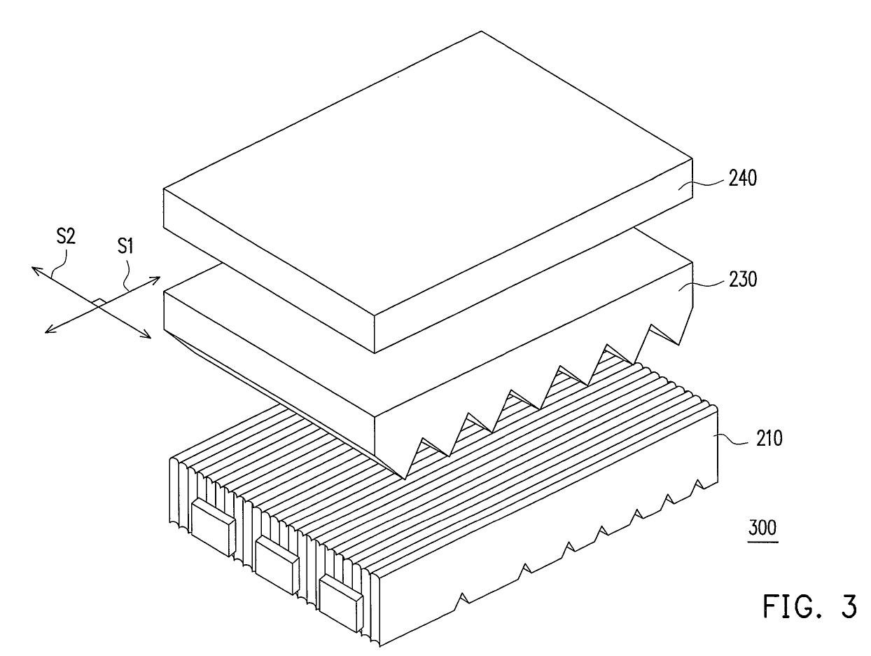

FIG. 3 is a schematic three-dimensional view illustrating a back light module according to the second embodiment of the present invention. Please refer to FIG. 3. The present embodiment is similar to the first embodiment. Hence, a detailed description thereof is omitted. Further, the main differences between the two embodiments are as follows. According to the present embodiment, a back light module 300 of the present embodiment further includes a diffuser 240 disposed on the prism sheet 230. Herein, the diffuser 240 can selectively function as a diffuser that diffuses light in a single direction or a common diffuser that diffuses light in multiple directions. The diffuser that diffuses light in a single direction can enhance dispersion of light along the stretching direction S1 of the cambered diffusion portions 212 to further increase the viewing angle along the direction S1. The diffuser that diffuses light in multiple directions can simultaneously enhance dispersion of light along the direction S1 and the direction S2. In other words, the viewing angles along both directions S1 and S2 are simultaneously increased.

More specifically, since light disperses along the direction S2 obviously after leaving from the prism sheet 230, the diffuser 240 ensures uniform brightness to further increase the range of the viewing angle for the liquid crystal display. Therefore, the quality of images provided by the liquid crystal display is significantly enhanced.

### The Third Embodiment

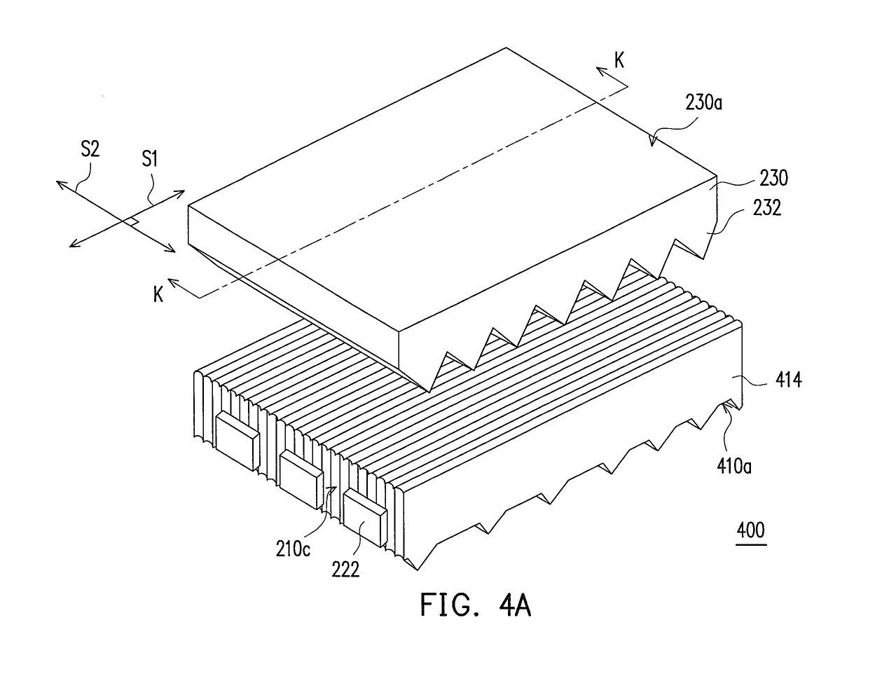

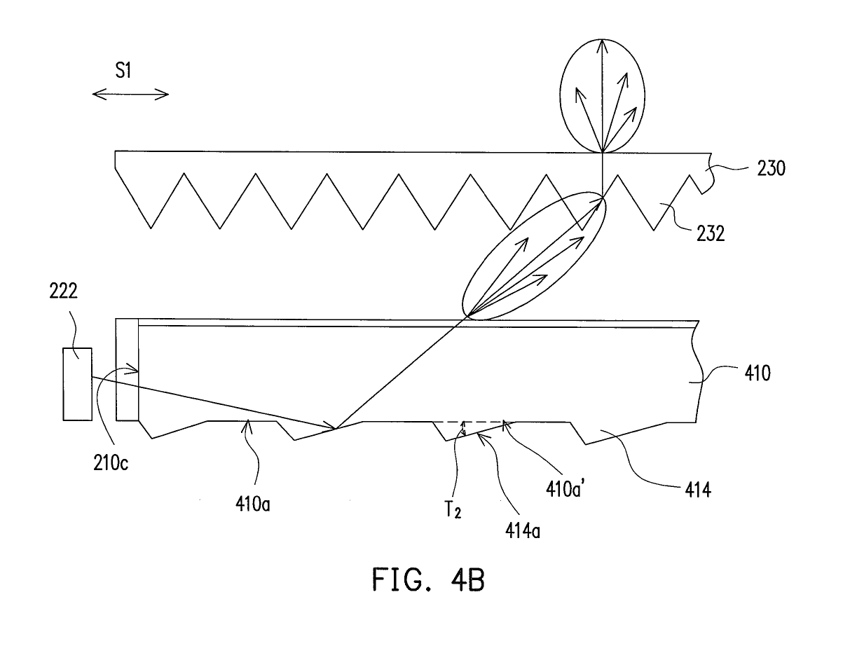

FIG. 4A is a schematic three-dimensional view illustrating a back light module according to the third embodiment of the present invention. FIG. 4B is a schematic cross-sectional view illustrating the back light module of FIG. 4A along line K-K. Please refer to FIG. 4A and FIG. 4B. The present embodiment is similar to the first embodiment. Hence, a detailed description thereof is omitted. Further, the main differences between the two embodiments are as follows. According to the present embodiment, a back light module 400 further includes a light guide plate 410. Herein, the light guide plate 410 includes a plurality of bottom prism units 414 protruding from the bottom surface 410a. More specifically, though the bottom prism units 414 are structurally different from the plurality of grooves 214 (please refer to FIG. 2A and FIG. 2B) described in the first embodiment, both the bottom prism unit 414 and the groove 214 function as light guide elements that are used to change the direction that light travels and guide light to the desired direction.

The bottom prism units 414 are paralleled to one another. Further, the stretching direction of the bottom prism units 414 is substantially perpendicular to the stretching direction S1 of the cambered diffusion portions 212. In addition, the stretching direction of the bottom prism units 414 is substantially parallel to the stretching direction S2 of the linear prisms 232. In the present embodiment, the further away the bottom prism units 414 are from the light incident surface 210c, the denser the distribution density of the bottom prism units 414.

Further, each bottom prism unit 414 has a light guiding surface 414a. Herein, an angle T2 is formed by the light guiding surface 414a and a reference plane 410a extended from the bottom surface 410a. In an alternative embodiment, the angle T2 is between 1° and 7°, for example.

In view of the above, the back light module of some embodiments of the present invention utilizes a light guide plate having a plurality of cambered diffusion portions and a prism sheet having a plurality of linear prisms protruding toward the light guide plate. Herein, the stretching direction of the linear prisms is substantially perpendicular to that of the cambered diffusion portions. Hence, when the light emitted by the light emitting units sequentially passes through the cambered diffusion portions and the linear prisms, the light is uniformly dispersed. In contrast to the conventional art, the brightness generated by the back light module of the present invention is not easily decayed as the viewing angle increases, resolving the issues of small viewing angle encountered by the conventional liquid crystal display.

Further, the light incident surface of the light guide plate may include a plurality of concave cambered surfaces or convex cambered surface. As a result, when light emitted by the light emitting unit enters the light guide plate, the cambered surface increase the angle of dispersion after the light enters the light guide plate. Consequently, reducing the distance between the periphery of the effective region and the light incident surface of the light guide plate increases the distribution area of the effective region.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A back light module, comprising:
a light guide plate having a bottom surface, a light output surface opposite to the bottom surface, and a light incident surface connected to the bottom surface and the light output surface, wherein the light guide plate comprises a plurality of cambered diffusion portions having cambered surfaces that are paralleled to one another on the light output surface;
a light emitting unit disposing next to the light incident surface; and
a prism sheet disposing over the cambered diffusion portions and having a plurality of linear prisms protruding toward the light guide plate, wherein the linear prisms are paralleled to one another and a stretching direction of the linear prisms is substantially perpendicular to a stretching direction of the cambered diffusion portions.

2. The back light module of claim 1, wherein the cambered surface of each cambered diffusion portion corresponds to a first arc angle that is between 39° and 140°.

3. The back light module of claim 1, wherein a width of each cambered diffusion portion is between 0.01 mm and 0.2 mm.

4. The back light module of claim 1, wherein a width of each cambered diffusion portion is W, a height of each cambered diffusion portion is H, and a value of W/H is between 2.8 and 11.7.

5. The back light module of claim 1, wherein the light incident surface is substantially perpendicular to the stretching direction of the cambered diffusion portions.

6. The back light module of claim 1, wherein the light incident surface comprises a plurality of curved surfaces and an end of the cambered diffusion portions is connected to the curved surfaces.

7. The back light module of claim 6, wherein the shape of the curved surfaces is selected from the group consisting of a convex cambered surface and a concave cambered surface.

8. The back light module of claim 7, wherein each concave cambered surface corresponds to a second arc angle that is between 62° and 164°.

9. The back light module of claim 8, wherein the light emitting unit comprises a plurality of light emitting diodes.

10. The back light module of claim 9, wherein the light emitting diodes are evenly spaced by a distance D1, a light emitted by the light emitting diodes generates an effective region on the light output surface of the light guide plate, a distance between the light incident surface and a periphery of the effective region is D2, and D1 and D2 satisfy the mathematical formula: D2≧P*D1, wherein P is a coefficient that decreases as the second arc angle increases.

11. The back light module of claim 10, wherein D1 and D2 satisfy the mathematical formula: D2≧0.59D1 when the second arc angle is 62°.

12. The back light module of claim 10, wherein D1 and D2 satisfy the mathematical formula: D2≧0.3D1 when the second arc angle is 164°.

13. The back light module of claim 1, wherein the bottom surface comprises a plurality of light guide elements that are paralleled to one another, and a stretching direction of the light guide elements is substantially perpendicular to a stretching direction of the cambered diffusion portions.

14. The back light module of claim 13, wherein each light guide element is a groove in the light guide plate, each groove comprises a light guiding surface such that the light guiding surface and a reference plane extended from the bottom surface form an angle that is between 1° and 7°.

15. The back light module of claim 14, wherein the grooves comprise a plurality of V-grooves.

16. The back light module of claim 13, wherein each light guide element is a bottom prism unit protruding from the light guide plate, each bottom prism unit comprises one light guiding surface such that the light guiding surface and a reference plane extended from the bottom surface form an angle that is between 1° and 7°.

17. The back light module of claim 1, further comprising a diffuser disposed on the prism sheet.
